(19) United States
(12) Patent Application Publication
(10) Pub. No.: US 2014/0077732 A1
(43) Pub. Date: Mar. 20, 2014

(54) DEVICE AND METHOD FOR MANAGING THE ELECTRIC BRAKING OF A VEHICLE

(71) Applicant: Ivan Modolo, Clermont-Ferrand Cedex 9 (FR)

(72) Inventor: Ivan Modolo, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/116,164

(22) PCT Filed: May 9, 2012
(86) PCT No.: PCT/EP2012/058565

§ 371 Date: Dec. 3, 2013

(30) Foreign Application Priority Data
May 13, 2011 (FR) 1154185

(51) Int. Cl. H02P 3/14; H02P 3/12

(52) U.S. Cl. CPC H02P 3/14; H02P 3/12
USPC 318/376

(57) ABSTRACT

A device for managing electric braking power includes a controller and a DC bus with a first pole that connects to a vehicle traction machine, a second pole that connects to a battery, and a connection point. The machine is associated with an inverter that delivers an electric braking power via the DC bus. A dissipation branch is connected to the DC bus at the connection point. The device also includes, on the DC bus between the connection point and the second pole, a current sensor and a charging switch that controls a current that flows on the DC bus from the first pole to the second pole. The controller evaluates a difference between a battery recharge limit current and the current on the DC bus, such that the charging switch is left closed if the current is less than the limit current.

### FIELD OF THE INVENTION

The present invention relates to road vehicles. It relates in particular to the braking systems of a road vehicle with electric traction. More particularly, it relates to the management of the electric braking power.

### DESCRIPTION OF THE PRIOR ART

Electric vehicles encompass vehicles in which the electric energy necessary to move them is stored in batteries and vehicles in which the electric energy is produced onboard at least in part, for example by a heat engine driving a generator or by a fuel cell. In electric vehicles, even though the braking of the vehicle is provided by a conventional friction mechanical braking system, it is known that one of the values of electric vehicles comes from their ability to regenerate, in the form of electricity, and store a portion of the energy generated during braking.

Specifically, since an electric machine is reversible, it can be used as a motor and also as an electric generator during the braking phases of the vehicle and in this case it transforms the mechanical braking energy into electric energy that the vehicle must absorb, preferably by storing it in order to save the energy necessary for the use of a vehicle, and inevitably by dissipating it when it is not or no longer possible to store it. This operating mode is often called “electric braking” or “regenerative braking” even when, in fact, the electric energy obtained by causing the electric machine(s) to operate is finally thermally dissipated at least partially.

As an illustration of the prior art, it is possible to cite Patent Application US 2003/0088343 which describes an electric traction chain for a hybrid motor vehicle fitted with an internal combustion engine and an electric machine which intervenes as an assistance for the driving of the vehicle. The electric machine is itself powered by a battery. More particularly, for the electric braking aspect, it is possible to cite Patent Application WO 2008/000636 which describes an electric braking mode, notably which evokes an electric energy management strategy programmed in an electronic regeneration module, the latter distributing the braking energy so as to recharge a bank of super capacitors and/or so as to dissipate the energy in an electric dissipation resistor. This document adds that the power of the means for storing the electric energy, in this instance super capacitors, can be limited, and that beyond the level of braking that this power allows, the electric power produced by the electric traction machine must then be directed to the dissipation means. This document, which concentrates on the organisation of a redundancy in order to reach a high degree of reliability of a purely electric braking, does not give details on the management of recharging the means for storing the electric energy.

The objective of the present invention is to propose the means for providing an optimal recharging of a means for storing electric energy while providing electric braking, by dissipation of the electric energy produced by an electric machine operating in generator mode, which is optimal and independent of the state of charge of the means for storing electric energy.

### BRIEF DESCRIPTION OF THE INVENTION

The invention proposes a device for managing electric braking power comprising a DC bus, the said DC bus comprising:
a pole for connection to an electric traction machine of a vehicle, the machine being associated with an inverter, the inverter delivering, in braking mode, over the DC bus, an electric braking power,
a pole for connection to a battery for storing electric energy, the device comprising:
a dissipation branch connected at a connection point to the DC bus, the said branch comprising an electronic dissipation switch connected in series to a dissipation resistor,
a current sensor on the DC bus, placed between the connection point of the DC bus and the pole for connection to a battery,
a controller receiving:
   an item of information on “battery recharge current limit”,
   an item of information “battery charged” when the battery is at its maximum charge,
   a measurement of the current on the DC bus delivered by the current sensor on the DC bus,
the controller comprising a comparator evaluating the difference between the battery recharge limit current and the current on the DC bus, the controller comprising a unit ensuring the control of the electronic dissipation switch so as, when the current on the DC bus is less than the battery recharge limit current, to control said electronic dissipation switch according to a cycle maintaining the battery charge current equal to the battery recharge limit current.

The invention also extends to a method for managing the electric braking mode of a vehicle comprising an electric traction machine of the said vehicle, comprising an electric circuit connecting the said electric machine to a battery for storage of electric energy and to a resistor for dissipation of electric energy, in which the dissipation current passing through the dissipation resistor is slaved to the difference between the battery charging current and the maximum charging current admissible for the said battery.

### BRIEF DESCRIPTION OF THE FIGURE

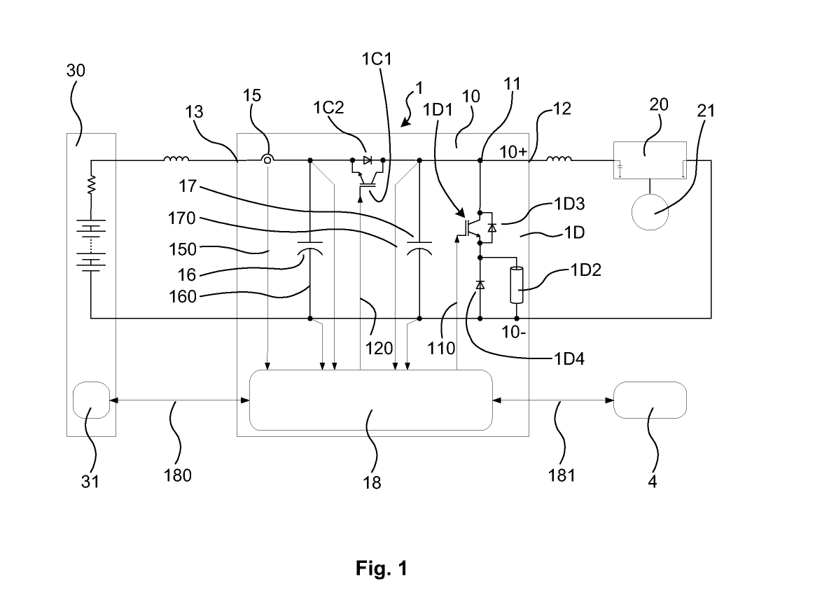

The rest of the description makes it possible to clearly understand all the aspects of the invention by means of FIG. 1 which illustrates a device according to the invention.

### DESCRIPTION OF BEST EMBODIMENTS OF THE INVENTION

FIG. 1 shows a device for managing electric braking power 1 connected on the one hand to an inverter 20 supplying an electric traction machine 21 of a vehicle and on the other hand to a battery 30 for storing electric energy. An overall central management unit of the vehicle 4 provides the general supervision of the vehicle and communicates with the device for managing the electric braking power 1 as will be explained below. The battery 30 comprises a battery management system 31. The device for managing electric braking power 1 comprises a DC bus 10 of which the positive line 10+ and the negative line 10− can be seen. The device for managing the electric braking power 1 comprises a first pole 12 for connection to the inverter 20, and a second pole 13 for connection to the battery 30.

The device for managing electric braking power 1 comprises a dissipation branch 1D connected at a connection point 11 of the dissipation branch 1D to the DC bus 10, in parallel with the inverter 20 supplying the electric traction machine 21. This dissipation branch 1D comprising an electronic dissipation switch 1D1, consisting of a transistor, in particular a transistor of the IGBT (Insulated Gate Bipolar Transistor) type, connected in series to a dissipation resistor 1D2. The electronic dissipation switch 1D1 controls the flow of current through the dissipation resistor 1D2. “Controlling the flow of current” means that the current is regulated as will be explained below.

Also seen is a diode 1D3 associated by construction of a transistor of the IGBT type, and a diode 1D4 which, when the electronic dissipation switch 1D1 is opened, allows the current that flowed in the dissipation resistor 1D2 to be cancelled out. This is particularly useful since the circuit is inductive. Note that the electronic dissipation switch 1D1 could be another type of semiconductor, for example a transistor of the MOS (Metal Oxyde Semiconductor) type, the choice being made by those skilled in the art depending on the practical details of construction.

The device for managing electric braking power 1 comprises an electronic charging switch 1C1 placed between the connection point 11 of the dissipation branch 1D to the DC bus 10 and the second pole 13 for connection to a battery of the DC bus. The said electronic charging switch is advantageously a transistor, as indicated above for the electronic dissipation switch 1D1. The electronic charging switch 1C1 controls the flow of current over the DC bus 10 from the first connection pole 12 to the second pole 13 for connection to a battery. “Controlling the flow of current” means that the battery-charging current is regulated as will be explained below.

The device for managing electric braking power 1 comprises a current sensor 15 on the DC bus 10 placed between the electronic charging switch 1C1 and the second connection pole 13. In practice, preferably, the current sensor 15 must be as close as possible to the battery 30 because there are (or may be) other consuming elements connected to the DC bus 10, upstream of the electronic charging switch 1C1, and the current sensor 15 monitors the battery current both when charging and when discharging.

The device for managing electric braking power 1 also comprises, mounted in parallel with the electronic charging switch 1C1, a diode 1C2 allowing the flow of current over the DC bus 10 from the second connection pole 13 to the first connection pole 12. Capacitors 16 and 17 are connected to the DC bus 10 on either side of the electronic charging switch 1C1 in order to smooth the voltage over the DC bus 10 when the electronic charging switch 1C1 and respectively the electronic dissipation switch 1D1 is closed or opened.

A controller 18 drives the device for managing the electric braking power 1. It can be seen that it receives from the battery-management system 31, via a CAN® bus 180, various items of information useful for the management of the braking power, of which a setpoint of “battery recharge current limit” Ic_recharge_max, a measurement of the current over the DC bus 10 delivered by the current sensor 15, via a line 150, a measurement of the voltage “U” over the DC bus 10, between the electronic charging switch 1C1 and the second connection pole 13, via a line 160, a measurement of the voltage over the DC bus 10, between the electronic charging switch 1C1 and the first connection pole 12, via a line 170, and various items of information coming from the overall central management unit of the vehicle 4 via a CAN® bus 181. The braking torque is managed by the overall central management unit of the vehicle 4 which, depending on the desire of the driver of the vehicle, sends via the CAN® bus 180 to the inverter 20 a torque setpoint. The inverter 20, up to the limit of the maximum admissible current (this maximum admissible current is determined by the controller 18) over the DC bus 10, controls the electric machine 21 so as to develop this torque. Finally, the controller 18 drives the electronic dissipation switch 1D1 and the electronic charging switch 1C1 by sending the appropriate electric signals over the dissipation control line 110 and over the charging control line 120, respectively. In this manner, the controller 18 manages the flow of power which runs up the drive chain and directs it to the correct location.

Let us now move on to the operation of the electric braking power management device 1.

The optimum recharging of an electrochemical battery, depending on the technology of the latter, may be carried out by a constant current, within the limit of a value Ic_recharge_max. For example, lithium polymer batteries or lithium ion batteries accept charging currents that are quite considerable but still less than the discharging currents. The determination of setpoint values for Ic_recharge_max (that is to say the setpoint of a battery recharge current limit) depends on the electric accumulator technology used, possibly other parameters such as temperature, state of charge, vehicle conditions, all things that are outside the context of the present invention. The said battery recharge current limit is a parameter which the present invention exploits cleverly.

The controller 18 comprises a comparator evaluating the difference between the battery recharge current limit and the current over the DC bus, the controller comprising a unit driving the electronic dissipation switch so as to leave the said electronic charging switch closed so long as the current over the DC bus is less than the battery recharge current limit and so as to drive the said electronic dissipation switch according to a cycle keeping the battery charging current equal to the battery recharge current limit when the current over the DC bus is not less than the battery recharge current limit.

Thus, the driving of the dissipation power, that is to say the portion of the power produced by the electric machine 21 that cannot be used to charge the battery 30, is carried out by an appropriate duty cycle of opening and closing of the electronic dissipation switch 1D1; the time during which the electronic dissipation switch 1D1 is open varies depending on the difference between the maximum battery charging current setpoint and the measurement of the current by the current sensor 15. By convention, “maximum charging mode” is the name for an operation of the electric braking power management device 1 during which the electronic charging switch 1C1 is permanently closed.

In maximum charging mode, the power sent over the DC bus 10 (by the inverter(s) 20 of the driving machines 21) is necessarily lower than the power that the battery 30 and the dissipation resistor 1D2 can absorb when 1D1 is closed. In this operating mode, the voltage applied to the terminals of the dissipation resistor 1D2 is equal to that of the battery (ignoring the voltage drops in the semiconductors and in the electric lines). The slaving controls the duty cycle of the electronic dissipation switch 1D1 so that the battery charging current 30 is at the maximum of what the said battery allows. The more the power produced by the driving machine(s) 21 increases, or the more the charging power of the battery 30 reduces, the more the duty cycle of the electronic dissipation switch 1D1 increases so as to reduce the power directed towards the battery.

When a predefined voltage value characteristic of a maximum charge is reached, there is a transition to a final phase of charging by keeping the voltage of the battery 30 constant. In this phase, the charging current is monitored, the latter reducing gradually. When this current falls below a given value (for example, Ic_recharge_max/20), the battery is considered fully charged.

At the battery 30 itself, the management of its charge is controlled by the battery management system 31. It is this battery management system 31 which, depending on the voltage of the battery, its temperature, etc., determines the said maximum recharge current Ic_recharge_max. This maximum recharge current Ic_recharge_max is the setpoint sent over the CAN® bus 180. The braking power management device 1 operates so as not to exceed this current. Specifically, in a first phase in which the predefined voltage of the battery is not reached, the battery management system 31 gives, over the CAN® bus 180 as Ic_recharge_max the limit given by the battery manufacturer. In a second phase, when the predefined voltage of the battery is reached, the battery management system 31 calculates and sends over the CAN® bus 180 a recharge current Ic_recharge which makes it possible to reach this predefined voltage. Gradually as the battery 30 is charged, this current Ic_recharge reduces.

Let us note that it is possible to reach a cyclic ratio of 100% for the electronic dissipation switch 1D1 and to find oneself in a situation in which the power sent over the DC bus 10 is greater than the total of the powers that the charging of the battery 30 and the dissipation in the dissipation resistor 1D2 can absorb when 1C1 is closed. In this case, or when the charging of the battery 30 is total, the electric braking power management device 1 goes into “maximum dissipation mode”, an operation during which the electronic charging switch 1C1 is permanently open and the electronic dissipation switch 1D1 is permanently closed (a duty cycle of 100%). There is no electric energy regeneration by charging of the battery 30. The voltage “U” of the DC bus 10 will increase and be stabilised so as to balance the dissipation power in the dissipation resistor 1D2 with that produced by the electric traction machine or machines 21 sending electric energy over the DC bus 10. If the power produced by the electric traction machine or machines 21 increases, the voltage of the bus increases and vice versa. If the power produced by the electric traction machine or machines 21 reduces sufficiently, to the point of being below the power that can be absorbed by the battery 30 and the dissipation resistor 1D2 we swing back into the maximum charging mode. Then the electronic charging switch 1C1 is closed and the slaving operated by the controller 18 regulates the duty cycle of the electronic dissipation switch 1D1 once more so as to slave the charging current to the maximum of what is allowed by the battery management system 31.

Preferably, a maximum of energy needs to be stored in the battery 30 then, when this is accomplished, advantageously a maximum of electric braking energy is dissipated in the dissipation resistor 1D2 in order to minimize (or remove condition of wear) the recourse to a mechanical braking by friction, thus reducing the wear of the brake pads and discs.

In practice, the controller 18 contains the means for calculating in real time the maximum possible dissipation power and the real dissipation power, and the maximum possible charging power and the real charging power for the purpose of optimal control. There is a transition from the maximum recharging mode to the maximum dissipation mode when the electronic dissipation switch 1D1 is permanently closed. The controller 18 adjusts the dissipation so as to recharge the battery to the maximum of what is technologically possible in the circumstances that exist at the time.

In conclusion, it has been seen above that, according to the invention, a method is proposed in which the dissipation current passing through the dissipation resistor is slaved to the difference between the battery charging current and the maximum charging current admissible for the said battery. Moreover, preferably, according to the method proposed by the invention, when the electric braking power is greater than the total of the battery recharging power and the dissipation power in the electric energy dissipation resistor, the battery is disconnected so as to allow a rise in the voltage of the electric circuit connecting the said electric machine to the dissipation resistor.

1-6. (canceled)

7. A device for managing electric braking power, the device comprising:
a DC bus, which includes:
a first pole that connects to an electric traction machine of a vehicle, the machine being associated with an inverter that delivers, in a braking mode over the DC bus, an electric braking power,
a second pole that connects to a battery for storing electric energy, and
a connection point;
a dissipation branch, which is connected to the DC bus at the connection point, the dissipation branch including an electronic dissipation switch connected in series to a dissipation resistor;
a current sensor positioned on the DC bus between the connection point and the second pole; and
a controller, which is structured to receive: limit information on a battery recharge current limit, maximum charge information indicating when the battery is at its maximum charge, and a measurement of a current on the DC bus provided by the current sensor,
wherein the controller includes a comparator, which evaluates a difference between the battery recharge limit current and the current on the DC bus, and
wherein, when the current on the DC bus is less than the battery recharge limit current, the controller causes the electronic dissipation switch to be controlled according to a cycle that maintains a battery charge current equal to the battery recharge limit current.

8. The device for managing electric braking power according to claim 7, wherein the electronic dissipation switch is a transistor.

9. The device for managing electric braking power according to claim 7, further comprising:
an electronic charging switch positioned between the connection point and the second pole, the electronic charging switch structured to control a flow of current over the DC bus from the first pole to the second pole, and
a diode mounted in parallel with the electronic charging switch, the diode structured to allow a flow of current on the DC bus from the second pole to the first pole.

10. The device for managing electric braking power according to claim 7, wherein the electronic charging switch is a transistor.

11. A method for managing an electric braking mode of a vehicle that includes an electric traction machine, the method comprising steps of:
providing an electric circuit that connects the electric traction machine to a battery, which stores electric energy, and to a dissipation resistor, which dissipates electric energy; and
slaving a dissipation current passing through the dissipation resistor to a difference between a battery charging current and a maximum charging current admissible for the battery.

12. The method for managing an electric braking mode according to claim 11, further comprising a step of, when an electric braking power is greater than a total of a battery recharging power and a dissipation power of the dissipation resistor, disconnecting the battery so as to allow a rise in a voltage of the electric circuit connecting the electric traction machine to the dissipation resistor.
